(19) United States
(12) Patent Application Publication
(10) Pub. No.: US 2003/0001393 A1
(43) Pub. Date: Jan. 2, 2003

(54) Linear motion wind driven power generator

(76) Inventors: Nicholas D. Staikos, Wilmington, DE (US); Dimitri N. Staikos, Wilmington, DE (US)

Correspondence Address: Dimitri N. Staikos, Green Acres, 1306 Quincy Drive, Wilminton, DE, 19803, US

(21) Appl. No.: 09/895,709

(22) Filed: Jul. 2, 2001

(51) Int. Cl. H02P 9/04; F03D 9/00

(52) U.S. Cl. 290/55

(57) ABSTRACT

A wind-driven power-generating apparatus having a plurality of sails which upon the action of the force of the wind are caused to move in unison linearly in a horizontal, or in a vertical direction and essentially perpendicular to the direction of the wind, wherein the leading ends of each of said sails are pivotally attached to an upper as well as to a lower sprocket-type chain engaging spatially disposed sprocket wheels so as to maintain said chains in a taught condition, while the trailing ends of said sails are similarly attached to said two chains through swiveling brackets permitting each sail to react to the force of the wind and cause the horizontal (or vertical) motion of the sails/chain assembly, and wherein said sprocket-type wheels are inclined so as to bring about a change in elevation of the sails in the downwind side versus the upwind side of the apparatus. The axis of at least one of said sprocket wheels is connected through a gear train to an electric power generator to convert the rotational energy of the apparatus to electricity.

### BACKGROUND OF THE INVENTION

As the populations of nations, their industrialization and other needs of individuals increase, so does the need to provide alternative sources of energy. Available sources are from wind, from wave, from tide or from solar energy. These are renewable sources which also reduce or completely eliminate harmful pollutants or other by-products which can affect the environment adversely.

The present invention addresses the need for the development of such devices which can be comparatively simple to install and operate and which can safely and efficiently extract energy from the winds.

### PRIOR ART

The familiar wind-mill on top of a tower has been used for the production of mechanical as well as electrical power. Later versions have reduced the number of radially extending vanes or sails to three or two with more efficient design so as to capture the force of the wind more efficiently. Progressively, designs of wind-driven power generators fell in the category of wind-turbines where greater wind masses were captured by wind-scoops having a large opening so that at the point of impact of the wind with the vanes or blades of the apparatus, the increased wind velocity resulted in increased power output.

Recently, in U.S. Pat. No. 6,113,350 issued to Liu, and in U.S. Pat. No. 4,168,439 issued to Palma, wind-driven apparatus was described where a plurality of blades (sails) were suspended at the periphery of vertical axle rotatable rings. In U.S. Pat. No. 5,758,911 issued to Gerhardt, a linear motion wind driven power plant was described where a number of sails are connected to carriages which in turn move linearly on a closed loop track bed. At least one electrical power generator generates electrical power from said movement of the carriages. The function of this apparatus as further described in the afore-mentioned reference, depends on sensing the lift generated by the wind upon the sail and on a controller which causes the sail to turn to a position wherein the sensed lift of the sail is approximately maximized.

It is noteworthy that in the above reference various other references to issued US Patents as well as to Foreign Patents dealing with linear motion wind-driven power plants are cited, none of which discloses prior art even in the least predating the concept of the present invention.

### DESCRIPTION OF THE PRESENT INVENTION

The present invention relates generally to wind-driven power generators; it relates particularly to a novel wind-driven power-generating apparatus which can capture the power of the wind at high efficiencies. A unique feature of the apparatus of the instant invention is the motion of its sails. This motion is linear, and can be in a horizontal or in a “vertical” direction. It is understood that the apparatus where the sails move in a “vertical” direction, may actually be moving in a direction variably inclined from vertical by the automatic repositioning of the apparatus so as to adjust to the force of the wind, as will be described. Automatic or manual adjustment of the apparatus operating with the sails moving in a horizontal direction may be accomplished by installing said apparatus on a turn-table as will also become obvious from the detailed description that follows.

It is noteworthy that the apparatus of the present invention, as a result of its design, presents a large cross-section to the on-coming wind and thus is capable of producing comparatively large amounts of electrical power when compared to propeller-type wind mills, or to the linear motion power plant described in U.S. Pat. No. 5,758,911, or those which employ air entrance nozzles to increase air velocity before said air impinges onto turbine-type blades to affect rotation of the turbine shaft (U.S. Pat. Nos. 4,164,382, 1,002,833 and 757,800 as examples). All these prior art devices present a low ratio of sail area to overall cross-section of the rotating member of the device.

The apparatus of the present invention not only presents a high sail area to its total cross-sectional area, but also permits each of its sails or vanes to capture the unobstructed full force of the wind twice in each revolution around the track, as will become evident from the description that follows.

The apparatus of the present invention may be set to operate in a vertical mode, where the sails move in a vertical direction or it may be set to operate in a horizontal mode where the sails move in a horizontal direction upon the action of the wind as has been mentioned.

The wind-driven power generator as described in one or another embodiment herein is adaptable for large- as well as for small-size installations, the latter for example, when such generators are placed on top of dwellings or on top of towers for the production of supplemental or full scale electrical power in rural or in city surroundings.

Other advantages of the present invention, together with the organization and manner of operation thereof, will become apparent from the following detailed description of the invention when taken in conjunction with the accompanying drawings wherein like reference numerals designate like elements throughout the several views, and wherein:

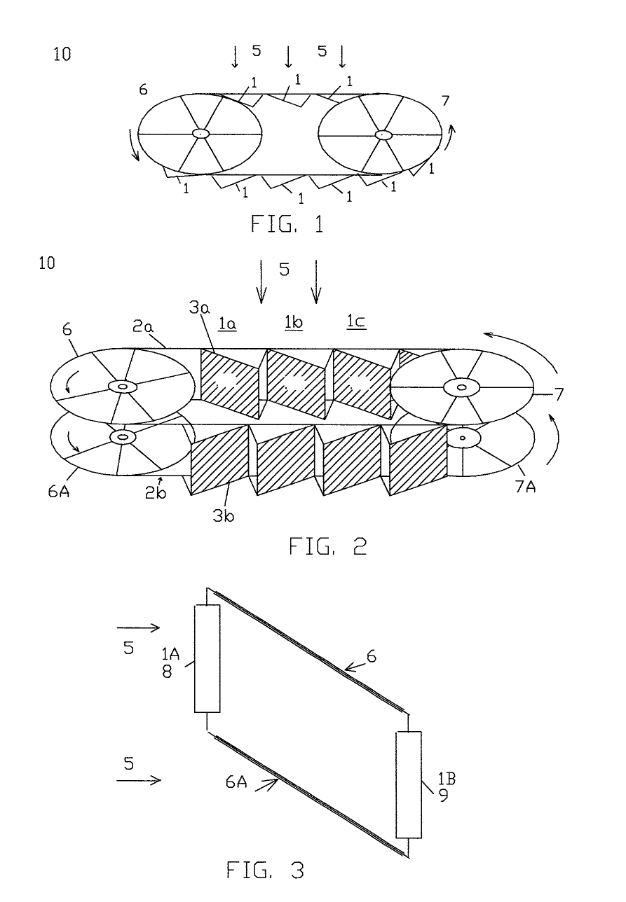

FIG. 1 presents a schematic plan view of the apparatus showing the position of the sails under the action of the wind.

FIG. 2 presents a schematic three-dimensional view of the apparatus, where a total of four sprocket wheels are used.

FIG. 3 presents a schematic end-view of the apparatus showing the placement of the sails (shown as rectangles) at two elevations as they move around the sprocket wheels from upwind to downwind positions respectively for the apparatus depicted schematically in FIG. 2.

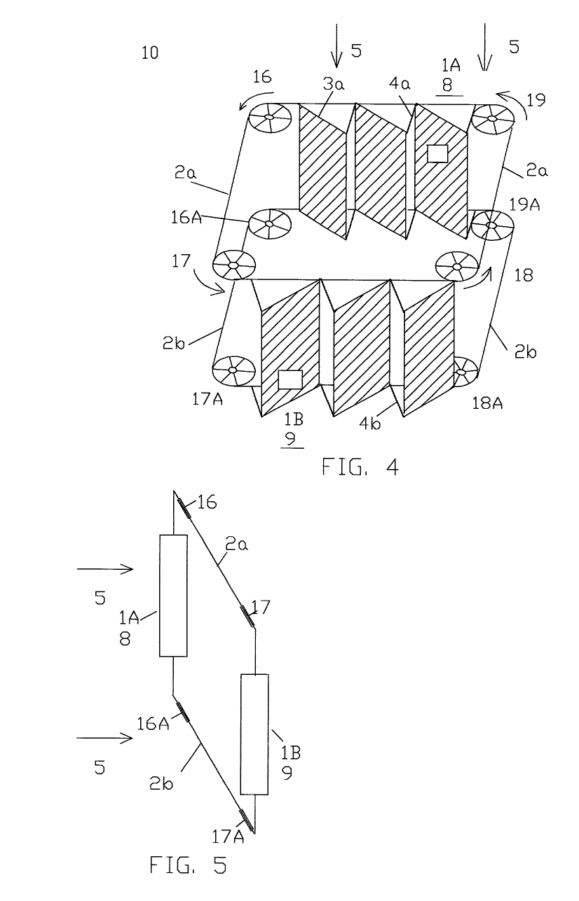

FIG. 4 presents a schematic three-dimensional view of the apparatus, where a total of eight smaller-size sprocket wheels are used.

FIG. 5 presents a schematic end-view of the apparatus showing the placement of the sails (shown as rectangles) at two elevations as they move around the smaller sets of sprocket wheels from upwind to downwind positions respectively for the apparatus depicted schematically in FIG. 4.

### DETAILED DESCRIPTION OF THE APPARATUS

The wind-driven power-generator constructed in accordance with one preferred embodiment of the present invention is indicated generally at 10 in FIGS. 1, 2, and 4. The sails 1 (a, b, c, etc.) may be rectangular or rhomboidal in shape. Sails made of flexible material such as cloth for example, are supported by an upper and by a lower boom, 3A and 3B respectively (FIGS. 2 and 4). In other embodiments, said sails may be constructed of rigid material. The overall width of each sail may vary by design and preferably a whole number of sails will be disposed onto the supporting chains 2A and 2B. The forward end of each of the booms 3A and 3B or of the rigid sail, is pivotally attached to each of the two said chains while their trailing ends are attached similarly to said chains by swivelling brackets 4A and 4B (FIG. 4) of variable length by design. Adjustments to the length of said brackets provides control of the speed of the sail/chain assembly particularly in the case of strong winds.

Said supporting endless chains 2A and 2B engage pairs of sprocket wheels 6, 7 and 6A, 6B (FIG. 2), or 16, 17/18, 19 and 16A, 17A/18A, 19A (FIG. 4), so that the sails/chain assembly moves linearly under the action of the wind.

The sails of the apparatus of our invention can be placed in close proximity to one another and still provide unobstructed wind power to those sails which have moved to the “rear” or downwind of the apparatus. This increases the ratio of sail area-to-overall area of the apparatus.

The sails 1 (-A, -B, -C, etc.), of the wind-powered generator, divert the direction of the wind 5 generating two force components, one in a direction grazing the surface of the sail, and the other component essentially perpendicular to the direction of the wind and essentially parallel to the direction of movement of the sail/sprocket-chain assembly. It is the latter force component which causes the linear motion of the sails/chain assembly. Thus mechanical power is delivered to the set of sprocket wheels 6, 6A and 7, 7A, (FIG. 2), or to the smaller wheels (FIG. 4), and through their shafts to the motor generator (not shown) to produce electrical power.

As noted earlier the apparatus of the present invention utilizes each and every sail twice, that is sail 1A for example, captures the full power of the wind when in position 1A/8 and again when in position 1B/9 as shown in FIGS. 2, 3, 4, and 5. Thus full utilization of the power of the wind by each and every sail is accomplished by the unique placement and tilt of said sprocket wheels. As a result, the sails receiving the wind at the “front” or upwind of the apparatus are at a different elevation than when they take positions at the “rear” or downwind of the apparatus as shown schematically in FIGS. 3 and 5. In these figures, the rectangle 1A or 8 represents one sail receiving the full thrust of the wind as it travels at the “front” of the apparatus and rectangle 1B or 9 represents the same sail after having traveled around the sprocket wheels 6, 6A in FIG. 3, (or sprocket wheels 16, 16A and 17, 17A in FIG. 4 ) on its return journey at the “rear” of the apparatus. The direction of the wind 5 is shown by the arrows where it is clear that all the sails at position 9 receive the full thrust of the wind unobstructed by all the sails in position 8.

This unique way of altering the elevation of the sails in the rear of the apparatus as compared to that in the front is accomplished by placing the axles of said sprocket wheels at an angle which may range from zero to over forty five degrees so as to provide a most efficient operation. For maximum utilization of the wind and for allowing sufficient space for the deflection of the sails responding to the thrust of the wind, these wheels preferably are set at forty five degrees for embodiments as may be represented schematically in FIGS. 2 and 3.

For large-size linear motion wind driven power generators based on the teachings of our invention, each set of sprocket wheels 6, 6A and 7, 7A in FIGS. 2 and 3, are replaced by smaller-size sprocket wheel sets (16, 16A), (17, 17A) and (18, 18A), (19, 19A) as shown schematically in FIG. 4 and in FIG. 5. Thus when the apparatus of our invention employing the arrangement as depicted schematically in FIG. 4, is used for small or for large-scale installations, the axles of said sprocket wheels may be inclined to values considerably higher than forty five degrees as shown in the schematic end-view in FIG. 5.

In the horizontal version of the apparatus, as depicted in FIGS. 2 and 3, the upper chain 2A and associated sprocket wheels 6, 7 are positioned at an elevation different from that of the lower chain 2B and its associated sprocket wheels 6A, 7A such that the distance between them is greater than the vertical dimension of each of the sails used. Similar constraints would apply to the embodiment depicted in FIGS. 4 and 5.

Particularly for large-scale installations, other modifications may be employed. For example the section of the sprocket chains 2A and 2B between the end sprocket wheels 6, 6A and 7, 7A of FIG. 2 (or 16, 16A/17, 17A and 18, 18A/19, 19A of FIG. 4), may be guided and supported by a series of small, idling sprocket wheels (not shown in these figures).

Details of the mechanism of support of said sails onto the two sprocket chains (also not shown on these figures) are not of significant consequence other than that they should allow each sail the ability to pivot from position 1A or 8 at the front to position 1B or 9 at the rear of the apparatus.

What we claim as our invention is:

1. A linear motion wind-driven power generator comprising a plurality of sails pivotally supported on two sprocket-type endless chains, each of said chains and said sails rotating about sets of sprocket wheels spatially disposed at different planes said sprocket wheels having their axles inclined at angles greater than zero degrees from the direction of the wind.

2. A linear motion wind-driven power generator as recited in claim 1 wherein the axle of at least one of said sprocket wheels is mechanically connected to the rotor of an electrical power generating motor.

3. A linear motion wind-driven power generator as recited in claim 1 wherein each of said chains is engaged to and rotates about a set of two sprocket wheels, each set of said sprocket wheels being spatially disposed at different planes and having their axles inclined at angles greater than zero degrees from the direction of the wind.

4. A linear motion wind-driven power generator as recited in claim 1 wherein each of said sprocket-type chains is engaged to and rotates about a set of four sprocket wheels, each set of said sprocket wheels being spatially disposed at two different planes and having their axles inclined at angles greater than zero degrees from the direction of the wind.

5. A linear motion wind-driven power generator as recited in claim 1 wherein the motion of the sprocket chains/sails assembly is substantially in a horizontal direction.

6. A linear motion wind-driven power generator as recited in claim 1 wherein the motion of the sprocket chains/sails assembly is substantially in a vertical direction.

7. A linear motion wind-driven power generator as recited in claim 6 wherein said power generator is supported on a horizontal shaft located at an elevation greater than the elevation of the center of said linear motion generator.
